(19) United States
(12) Patent Application Publication
(10) Pub. No.: US 2018/0087923 A1
(43) Pub. Date: Mar. 29, 2018

(54) METHOD FOR LOCATING AVAILABLE SITES

(71) Applicant: BLUECARSHARING, Vaucresson (FR)

(72) Inventor: Guillaume HUGLA, Paris (FR)

(21) Appl. No.: 15/547,761

(22) PCT Filed: Jan. 28, 2016
(86) PCT No.: PCT/EP2016/051776

§ 371 Date: Jul. 31, 2017

(30) Foreign Application Priority Data
Feb. 9, 2015 (FR) 1551021

(51) Int. Cl. G01C 21/36; G06F 17/30; G08G 1/14

(52) U.S. Cl. CPC G01C 21/3685; G06F 17/30241; G08G 1/144; G01C 21/3682; G01C 21/367

(57) ABSTRACT

A method for locating at least one available site from a plurality of sites, including:
identifying a predetermined number of available sites the closest to a reference position; and
displaying, in a display window the positions of the identified sites on a geographical map;
   an automatic adjustment of the display scale of the geographical map depending on:
at least one dimension of the display window; and
at least one distance separating at least one of the identified sites from the reference position;
   such that identified sites are all displayed in the display window.

It also relates to methods for reserving a vehicle, a parking space and a journey implementing such a location method.

The present invention relates to a method for locating at least one available site among a plurality of sites distributed over an area. It also relates to methods for reserving a vehicle and a parking space within the context of an installation for the automated rental of vehicles, implementing such a locating method.

The field of the invention is the field of the identification of an available site among a plurality of sites distributed over an area, and in particular human-machine interfaces for assisting a user during such locating.

### STATE OF THE ART

Automated vehicle rental is a field experiencing rapid growth. In population centres where it is desirable to reduce the number of vehicles present in the area, automated vehicle rental systems are being established, such as for example for electric vehicles or bicycles.

These installations comprise rental sites distributed over an area making it possible to rent a vehicle or to return a vehicle at the end of rental. Now, as the capacity of each rental site is limited, it is not certain whether a particular rental site is available for renting a vehicle or returning a vehicle at the end of rental.

More generally, within the context of a service provided at a plurality of sites distributed over an area, it becomes necessary to inform a user of the availability of a particular site, in order to avoid the user attending a site that would ultimately not be available.

Methods are known that make it possible to inform a user of the geographical location of the sites offering a specific service by displaying the position of these sites on a geographical map, for example via a smartphone app.

Now, these methods merely display the geographical position of the sites concerned on a map in a raw fashion. The user must then manipulate the map and the display scale of the map in order to be able to find his position on said map. Then, the user must interpret the displayed information in association with each site in order to determine if a site is available, and select it. All these steps can be complex for an inexperienced user; they are time-consuming, not very ergonomic and delay the identification of an available site.

A purpose of the invention is to overcome the aforementioned drawbacks.

A further purpose of the invention is to propose a method for more quickly locating an available site among a plurality of sites.

A further purpose of the invention is to propose a method for locating an available site among a plurality of sites, which is less time-consuming and more ergonomic for the user.

Finally, a further purpose of the invention is to propose a method for locating an available site among a plurality of sites, which is simpler for the user to understand and use.

### DISCLOSURE OF THE INVENTION

The invention proposes to achieve at least one of the aforementioned purposes by a locating method, in particular for identifying and displaying the geographical position, of at least one available site among a plurality of sites distributed over an area and each capable of being in an available state or an unavailable state, with respect to a geographical position, called reference position, said method comprising the following steps:
automated identification, among said plurality of sites, of a predetermined number of available sites closest to said reference position, depending on location data of said sites, and on at least one data, called state data, indicating for each site the availability or not of said site; and
displaying, in a display window, in particular on a display screen of a device, positions of said sites identified on a geographical map;
   characterized in that it comprises an automatic adjustment of the display scale of said geographical map depending on:
at least one dimension of said display window; and
at least one distance separating at least one of said identified sites from said reference position;
   so that said identified sites are displayed in said display window.

Thus, the method according to the invention makes it possible to identify and display directly in the display window, for example following a request from the user, the geographical positions of the available sites. Thus, in all cases, the user will see an available site among the plurality of sites and will not need to interact with the display window in order to identify an available site. Locating an available site among a plurality of sites becomes less time-consuming and less complex by means of the method according to the invention.

In addition, the method according to the invention makes it possible to adapt the display scale of the map on which the available sites are located, depending on the distance separating the available sites from the reference position, and optionally on the distance between said available sites. Thus, the user has a suitable display scale available each time in order to judge the distance to each of the available sites, which is more ergonomic, and enables a choice to be made more rapidly.

According to a non-limitative embodiment, the sites distributed over an area can form part of one and the same installation, such as for example an automated rental installation for electric vehicles, in which each site is a rental station allowing a vehicle to be rented and/or a vehicle to be returned at the end of rental.

Alternatively, the distributed sites can be sites that are independent of one another but offering the same service or a similar service.

In any event, each site can be linked to a central server, such that the availability data of each site can be accessed via, or on, said central server.

Preferentially, adjusting the display scale can comprise determining, and a selection, of the largest display scale allowing the display of the geographical location of the furthest identified site among the available identified sites.

Thus, the user can benefit from maximum detail while displaying all the identified available sites, which is ergonomic for the user and makes it possible for the choice of an available site to be made more quickly.

The display step can also comprise displaying, in the display window, at least one, in particular each, site that is unavailable and closer to the reference position compared to the site that is the furthest from the reference position among the identified available sites.

Such a display of an unavailable site can be produced separately from the available sites, for example by using a different colour from the one used for the available sites, and/or by using a symbol of a smaller size in comparison with the size of a symbol used for the available sites.

According to a particularly advantageous feature, the identification step can be carried out progressively in (a) phase(s) by increasing distance segments from the reference position, by incrementing a predetermined distance value.

For example, identification of the available sites can be carried out among a first group of sites located at a distance less than or equal to ΔD with respect to the reference position. When a predetermined number of available sites are identified from this first group of sites, then it is not necessary to consult the other sites. If the contrary holds true, i.e. it is not possible to identify a predetermined number of available sites within this first group of sites, then the identification step takes account of a second group of sites located at a distance comprises between ΔD and 2ΔD with respect to the reference position, and so on and so forth.

Of course, the distance increment, i.e. the value ΔD, can be fixed or variable at each iteration.

In addition, the distance increment can be adjustable:
by the user, and/or
by an operator, and/or
by a remote server, for example a central management server of an installation for the automated rental of vehicles when the method according to the invention is implemented within the context of such an installation.
   Thus, the method according to the invention makes it possible to carry out an identification of a predetermined number of available sites while taking less time and fewer resources with respect to a situation in which all the sites are considered.

Furthermore, the identification step may take into account only the sites located at a distance less than or equal to a maximum distance with respect to the reference position.

In fact, there is a very high probability that when an available site is located too far from the reference position, then the user will not select it. In this case, the benefit of displaying such a site is very small, or even non-existent. The method according to the invention thus allows the sites that are too far from the reference position to be disregarded, and thus to reduce the resources and time necessary for executing the method according to the invention.

The maximum distance can advantageously be capable of adjustment:
by the user, and/or
by an operator, and/or
by a remote server, for example a central management server of an installation for the automated rental of vehicles when the method according to the invention is implemented within the context of such an installation;
   for example depending on a user profile, which makes it possible to personalize the method for each user.

Similarly, the predetermined number of sites can be adjusted:
by the user, and/or
by an operator, and/or
by a remote server, for example a central management server of an installation for the automated rental of vehicles when the method according to the invention is implemented within the context of such an installation;
   for example depending on a user profile or a geographical area in which the reference position is located.

Preferentially, the predetermined number of available sites is greater than 1, and more particularly equal to 3.

According to a preferred embodiment, the reference position can be a position determined on the fly, in particular in real time, in an automated manner depending on geographical location data provided by a device utilizing said method, for example a smartphone, a tablet, a phablet, etc.

Such geographical location data can be provided by a GPS module equipping such a device or by triangulation.

According to an alternative embodiment, the reference position can be a position for which information has been given beforehand, and common to several iterations of the method according to the invention.

In this case, determining the reference position can be carried out by automated reading of data representing said position for which information has been given beforehand and stored, for example within a user device or in a remote server in association with a user identifier.

According to yet another embodiment, the method according to the invention can also comprise a step of indicating the reference position by the user.

According to a first embodiment, indicating the reference position can be carried out by selecting a reference position from a plurality of geographical positions that have previously been given and stored within a user device or in a remote server. Such a selection can for example be carried out within a menu or a list, in particular scrolling, displayed on a display screen. The selection can be carried out using a pointing device or by contact on a touch screen.

Alternatively or in addition, the reference position can be input by the user, either by means of a keyboard or by pointing on a geographical map using a pointing device or by contact on a touch screen.

When the method comprises selecting the reference position from a list or a menu, in particular scrolling, the position in said list or in said menu, of at least one geographical position, can be adjusted depending on the actual geographical position or on the current time.

For example, when the current geographical position corresponds to, or is close to, a business address, it is highly likely that the reference position corresponds to this business address or to a personal address for which information has been given beforehand. These two addresses can be moved up the list in order to make their selection quicker.

According to another example, when the method is executed in the morning, it is highly likely that the reference position corresponds to a business address and respectively in the evening, to a personal address. This address can be moved up the list in order to make its selection quicker.

Advantageously, the method according to the invention can also comprise, for at least one identified available site, a step of:
determining a distance separating said identified available site from the reference position, and
displaying said distance in association with said identified available site, for example in or close to the display window.

Such a distance advantageously corresponds to a route distance between the reference position and said site, for example when said route is travelled on foot.

The method according to the invention can advantageously be used for identifying a site for the automated rental of available vehicles comprising:
a vehicle available for rental, with respect to a reference position, called departure position; or
a parking space available for returning a rented vehicle, with respect to a reference position, called arrival position; or within an installation for the automated rental of vehicles comprising a plurality of rental sites for renting a vehicle and/or for returning a rented vehicle.

According to another aspect of the same invention, a method is proposed for reserving a vehicle within the context of an installation for the automated rental of vehicles comprising a plurality of automated rental stations for vehicles that are distributed over an area, characterized in that it comprises:
locating at least one available station comprising at least one vehicle available for rental, with the locating method according to the invention.
selecting an available station, and
reserving at least one vehicle for rental, in said selected station, for example by storing, in a database, a data relating to a user in association with an identifier of said selected station or of a vehicle present in said selected station.

According to yet another aspect of the same invention, a method is proposed for reserving a parking space within the context of an installation for the automated rental of vehicles comprising a plurality of rental stations distributed over an area, each station comprising at least one parking space, said method comprising the following steps:
locating at least one available station comprising at least one available parking space, with the locating method according to the invention,
selecting an available station, and
reserving at least one parking space in said selected station, for example by storing, in a database, a data relating to a user in association with an identifier of said selected station or of a parking space in said selected station.

According to yet another aspect of the invention, a method is proposed for reserving a journey within the context of an installation for the automated rental of vehicles comprising a plurality of automated rental stations for vehicles that are distributed over an area, said method comprising the following steps:
reserving a vehicle in an available station, with respect to a reference position, called departure position, with the method for reserving a vehicle according to the invention, and
reserving a parking space in an available station, with respect to a reference position, called arrival position, with the method for reserving a parking space according to the invention.

According to yet another aspect of the invention, a computerized application is proposed for:
a portable device, in particular of the smartphone, tablet or phablet type, or
a fixed device, of the desktop computer or terminal type;

private or public, comprising the instructions that can be executed by said device in order to implement all the steps of the locating method, and/or of the method for reserving a vehicle, and/or of the method for reserving a parking space, and/or of a method for reserving a journey according to the invention.

### DESCRIPTION OF THE FIGURES AND EMBODIMENTS

Other advantages and characteristics will become apparent on examination of the detailed description of embodiments that are in no way limitative, and the attached drawings, in which:

FIG. 1 is a diagrammatic representation of an automated rental installation for vehicles implementing the method according to the invention;

FIG. 2 is a diagrammatic representation in the form of a flowchart of a method for locating at least one available site according to the invention;

FIGS. 3a and 3b are diagrammatic representations of a display window obtained by the method in FIG. 2;

FIG. 4 is a diagrammatic representation in the form of a flowchart of an example of the method for reserving a vehicle utilizing the method in FIG. 2;

FIG. 5 is a diagrammatic representation in the form of a flowchart of a example of the method for reserving a parking space utilizing the method in FIG. 2; and

FIG. 6 is a diagrammatic representation in the form of a flowchart of an example of a method for reserving a journey.

It is well understood that the embodiments that will be described hereinafter are in no way limitative. Variants of the invention can be considered comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

In the figures and in the remainder of the description, elements common to several figures retain the same reference.

The examples described below relate to automated rental of electric vehicles over several rental sites. Of course, the invention is not limited to a use in such an installation.

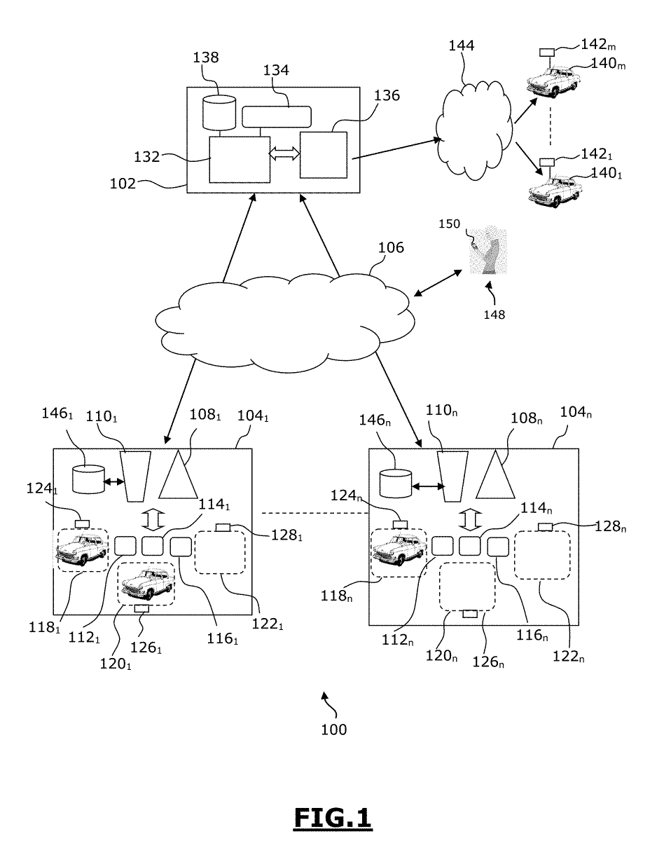

FIG. 1 is a diagrammatic representation of an installation for the automated rental of electric vehicles in which the invention can be implemented.

The installation 100 shown in FIG. 1 comprises a central site 102 connected to several sites—or stations—104₁-104ₙ, called rental sites, through a wireless communication network 106, for example GPRS, or a wired network, for example of the DSL or LAN type. Preferably, each site 104 is linked to the central site 102 via the two separate networks, which allows a continuous connection even if one of the networks fails.

Each rental site 104 comprises a rental terminal 110 for renting a vehicle and several charging terminals 112-116, each charging terminal being provided for charging a vehicle equipped with an electric battery at a parking space, namely parking spaces 118-122.

Certain rental sites 104 also comprise a subscription terminal 108 for registering a new subscriber.

Each parking space of a rental site 104 comprises a presence detection module 124-128, namely weighing means, a camera and/or an infrared sensor and/or a detector of an electrical connection to a vehicle and/or a radar, connected to the rental terminal 110 of the rental site 104.

The central site 102 can be connected directly to each of the terminals of a rental site 104 through the network 106 or only to the subscription terminal and/or to the rental terminal and/or to the charging terminals 112-116.

At least two terminals of a rental site are connected together through a wired connection (not shown).

The central site 102 comprises a central management server 132, a synthesis module 134 and a communication module 136, called central communication module.

The central site 102 also comprises a database 138 in which are recorded:
in association with the identifier of a vehicle offered for rental, the identifier of the user to whom this vehicle is rented/reserved, optionally the state (rented/free/under maintenance/reserved) for each vehicle,
in association with the identifier of a parking space 118-122, the identifier of the user for whom this parking space is reserved for returning a vehicle thereto at the end of rental, optionally the state (reserved/occupied/free) for each parking space 118-122,
in association with an identifier of a station 104, the state of availability of this station,
in association with an identifier of a user, data representing at least one preferential value of a parameter associated with this user.

The central site 102 is in communication with electric vehicles 140₁-140ₘ during rental, via the central communication module 136 and a communication unit 142₁-142ₘ, called vehicle communication unit, arranged in each of the vehicles, through a wireless communication network 144, for example GPRS, which can be the same as the communication network 106.

By means of the central communication module 136 and the vehicle communication units 142, the central site 102 exchanges data with each of the vehicles 140.

Each vehicle communication unit 142 is connected to a user interface (not shown), for example an interface of a geolocation unit of the vehicle, which may comprise a touch screen, for displaying the data on a map and in order to take account of the data inputs carried out by the user of the vehicle 140.

Each rental station 104 comprises a database 146 in which the state, reserved or not, of each parking space 118-122 of the rental site 104 is recorded. This database 146 also stores the state of availability of each parking space, namely occupied or free.

A user 148 is able to interact with the installation 100, in particular with the remote site 102, and also more particularly with the server 132, via:
a terminal at a rental station, and in particular the rental terminal 108,
the user interface of each vehicle 140, and/or
an application executed for example on a portable user device 150 of the smartphone type.

As a result, the method according to the invention, and in particular the embodiments described below, can equally well be implemented at a rental site, in a vehicle or also through the device 150.

However, for reasons of clarity, the examples described hereinafter are assumed to be carried out through a portable user device, such as the device 150.

In an installation for the automated rental of vehicles, at least two state data are associated with each site:
a state data, called vehicle state data, indicating the availability or not of a site for renting a vehicle: the site is available if there is at least one available vehicle at the location, and not available otherwise; and
a state data, called parking space state data, indicating the availability or not of a site for returning a vehicle at the end of rental: the site is available if there is at least one parking space available for returning the vehicle thereto, and not available otherwise.

As a result, when the method for locating an available site according to the invention is executed in order to identify sites available for renting a vehicle, the state data taken into account is the vehicle state data. When the method for locating an available site according to the invention is executed in order to identify the available sites for returning a rented vehicle, the state data taken into account is the parking space state data.

Each state data can be a binary data, for example 1 for available and 0 for not available. Alternatively, each data can be a data that is capable of adopting several values, and in particular the number of available vehicles for the vehicle state data, and the number of available parking spaces for the parking space state data.

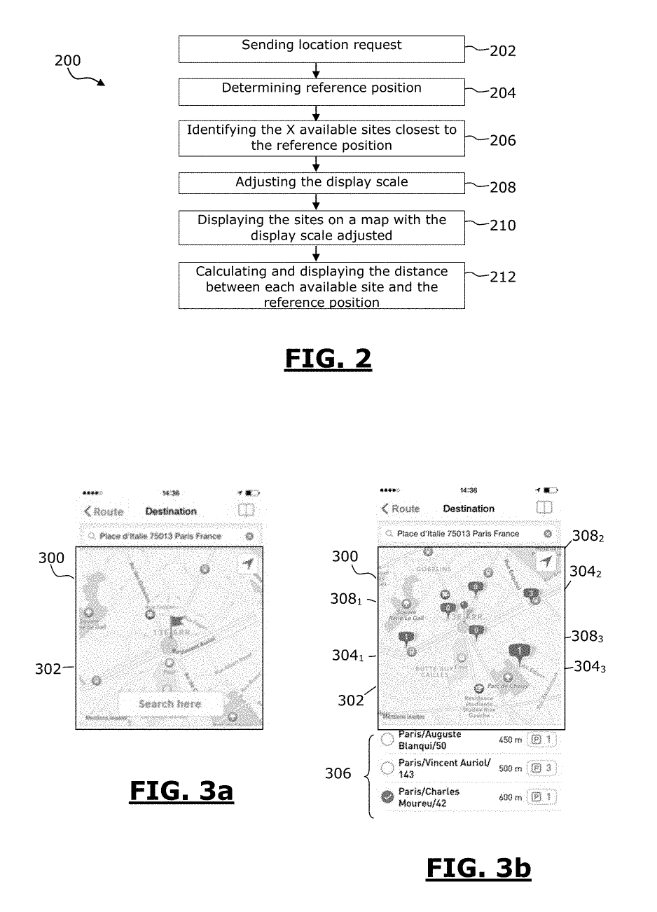

FIG. 2 is a diagrammatic representation in the form of a flowchart of an example of the method for locating an available site, and in particular an available automated rental station among stations 104₁-104ₙ.

FIGS. 3a and 3b are diagrammatic representations of a display window on a display screen, in particular a touch screen, of a device, for example the device 150, and obtained by the method 200.

The method 200 shown in FIG. 2 comprises a step 202 of sending a request for locating available sites, for example by starting an application or by pressing a button of an application that is being executed.

Following step 202, a step 204 determines the reference position to be used in order to carry out locating available sites.

According to a first embodiment, the reference position can be determined in an automated manner. For example, when the reference position corresponds to the user's current position, i.e. the place where the user is located, step 204 can comprise automated detection of the reference position, provided for example by a geolocation module with which the device 150 is equipped. Alternatively, or in addition, the reference position can be determined in an automated manner depending on the current time. For example, when it is 18.00 on a weekday, there is a high probability that the user is at his workplace, for which information has been given beforehand. In this case, the geographical position of his workplace is selected in an automated manner as the reference position.

According to another embodiment, and regardless of the reference position, step 204 can comprise the user entering a reference position:
by input of the position using a keyboard,
by input of the position or address from a list of positions for which information has been given beforehand, and/or
when the user device allows this, by pointing to a position on a map displayed on a screen, for example a touch screen, of the user device.

FIG. 3a is an example of a display screen comprising a display window 300 in which the reference position 302 is displayed. In the example shown, the reference position 302 is indicated by the user, on the geographical map, by touch selection via a touch-sensitive display screen.

Once the reference position has been determined, the method 200 comprises a step 206 of identifying a predetermined number, denoted X, of available sites closest to the reference position.

To this end, step 206 proceeds by iteration based on a distance criterion with respect to the reference position. The availability data relating to a first group of sites located at a distance of less than or equal to ΔD with respect to the reference position are loaded. Starting with the site that is the closest to the reference position, the availability of each site in the first group is tested. If the site is identified as available, then its identifier is stored in a first list. Otherwise, its identifier is stored in a second list.

A site is available if the state data of this site indicates that it is available. In order to determine if a site is available, the method consults the state data of this site.

As soon as X available sites are identified in the first group, step 206 is ended and it is not necessary to consult the other sites. Otherwise, the data relating to a second group of sites located at a distance comprised between ΔD and 2ΔD with respect to the reference position are loaded, then tested. These operations are repeated, and so on, until the X closest available sites are identified.

When the X closest available sites are identified, the method 200 comprises a step 208 of adjusting the display scale. This step 208 determines, depending on the dimensions of a display window and on the distance separating the reference position and the furthest site stored in the first list during step 206, the largest display scale for a geographical map allowing the sites of said first list to be displayed in said display window.

During a step 210, the geographical positions of the sites forming part of the first list are displayed in the display window on a display screen of the user device, for example using a symbol displayed at their geographical positions on a geographical map. Optionally, the unavailable sites tested during step 206, the identifiers of which are stored in the second list, can also be displayed, with a symbol that differentiates them from the available sites, for example by its colour and by its size.

In addition, the method 200 can comprise during the display step 210 or during an additional display step, a display for each available site of the number of vehicles available, or parking spaces available, at said available site.

The method 200 can moreover comprise, for each available site, a step 212 of calculating and displaying a distance between said available site and the reference geographical position.

FIG. 3b is an example of a display screen obtained at the end of the method 200. The map displayed on the display screen in FIG. 3b shows, in addition to the reference position 302, the geographical position of each available site 304₁-304₃, in the case where X=3, with for each available list the number of available vehicles, or parking spaces, respectively.

On the display screen, below the map displayed in the display window 300, a list 306 is displayed of the names of the available sites 304₁-304₃ with for each available site 304₁-304₃ the distance between said available site 304₁-304₃ and the reference position 302. The map also comprises a display of the geographical position of each unavailable site 308₁-308₃.

FIG. 4 is a diagrammatic representation in the form of a flowchart of an example of the method for reserving a vehicle implementing the method 200 in FIG. 2.

The method 400 shown in FIG. 4 comprises a step 402 of identifying and displaying the available sites for renting a vehicle, according to the method 200 shown in FIG. 2, with respect to a reference position, called departure position. This departure reference position can be determined according to any one of the possibilities described above with reference to step 204.

The state data taken into account for determining the availability or not of each site within the context of the method for reserving a vehicle is the vehicle state data, described above.

Step 402 identifies and displays a predetermined number of sites, for example three sites, where the user can rent a vehicle.

During a step 404, the user selects an available site from the available sites offered in step 402.

Following this selection, the method 400 comprises a step 406 of reserving a vehicle. Such a reservation can for example be carried out by storing an identification data associated with the user with an identification data associated with an available vehicle located at the selected site. This storage can be carried out at the available site or at a central site.

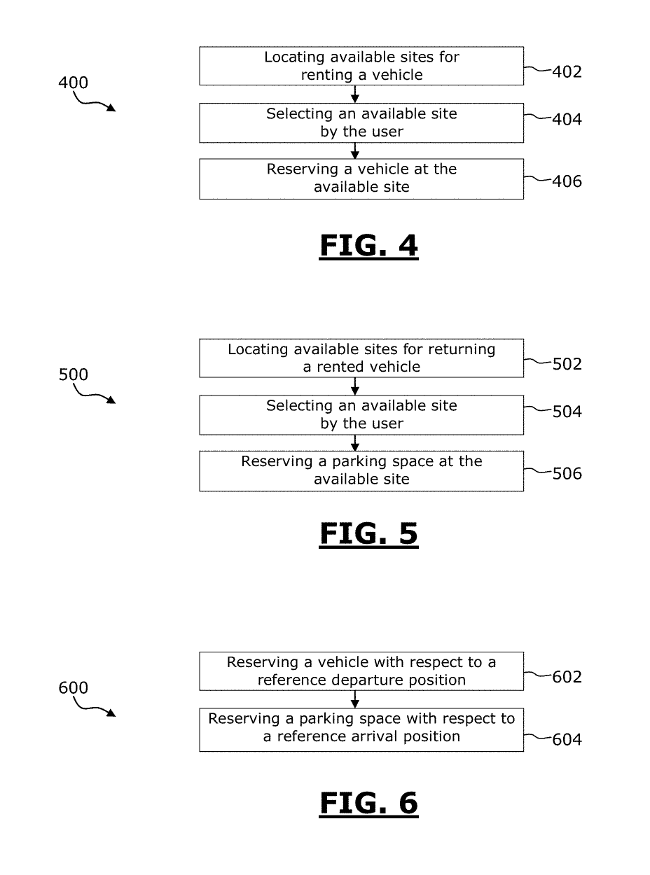

FIG. 5 is a diagrammatic representation in the form of a flowchart of an example of the method for reserving a parking space implementing the method 200 in FIG. 2.

The method 500 shown in FIG. 5 comprises a step 502 of identifying and displaying the available sites for returning a rented vehicle according to the method 200 shown in FIG. 2, with respect to a reference position, called arrival position. This arrival reference position can be determined according to any one of the possibilities described above with reference to step 204.

The state data taken into account for determining the availability or not of a site within the context of the method for reserving a parking space is the parking space state data, described above.

Step 502 identifies and displays a predetermined number of sites, for example three sites, comprising at least one available parking space where the user can return a vehicle at the end of rental.

During a step 504, the user selects an available site from the available sites offered in step 502.

Following this selection, the method 500 comprises a step 506 of reserving a parking space. Such a reservation can for example be carried out by storing an identification data associated with the user with an identification data associated with an available parking space located at the selected site. This storage can be carried out at the available site or at a central site.

FIG. 6 is a diagrammatic representation in the form of a flowchart of an example of the method for reserving a journey within the context of an installation for the automated rental of vehicles.

The method 600 comprises a step 602 for reserving a vehicle with respect to a reference geographical departure position, according to the method 400 described with reference to FIG. 4.

The method 600 then comprises a step 604 of reserving a parking space with respect to a reference geographical arrival position, according to the method 500 described with reference to FIG. 5.

Of course the invention is not limited to the examples which have just been described.

1. A method for locating at least one available site among a plurality of sites distributed over an area, each capable of being in an available or unavailable state, with respect to a geographical position, called reference position, said method comprising the following steps:
automated identification, among said plurality of sites, of a predetermined number of available sites closest to said reference position, depending on location data of said sites, and on at least one data, called state data, indicating for each site the availability or not of said site; and
displaying, in a display window, the positions of said identified sites on a geographical map;
an automatic adjustment of the display scale of said geographical map depending on:
at least one dimension of said display window; and
at least one distance separating at least one of said identified sites from said reference position;
such that said identified sites are all displayed in said display window.

2. The method according to claim 1, characterized in that the adjustment comprises determining a display scale that is the largest allowing the display of the position of the identified site that is the furthest among the identified sites.

3. The method according to claim 1, characterized in that the display step also comprises displaying, in the display window, at least one unavailable site which is closer to said reference position compared with the site that is the furthest from said reference position among the identified available sites.

4. The method according to claim 1, characterized in that the identification step is carried out progressively in phases(s) by increasing distance segments from the reference position, by incrementing a predetermined distance value.

5. The method according to claim 1, characterized in that the identification step only takes into account the sites located at a distance less than or equal to a maximum distance with respect to the reference position.

6. The method according to claim 5, characterized in that the maximum distance can be adjusted:
by the user, and/or
by an operator, and/or
by a remote server, for example a central management server of an installation for the automated rental of vehicles when said method is implemented within the context of such an installation.

7. The method according to claim 1, characterized in that the predetermined number of sites can be adjusted.

8. The method according to claim 7, characterized in that said predetermined number can be adjusted:
by the user, and/or
by an operator, and/or
by a remote server, for example a central management server of an installation for the automated rental of vehicles when said method is implemented within the context of such an installation.

9. The method according to claim 1, characterized in that the reference position is a position determined on the fly in an automated manner depending on geographical location data of a device utilizing said method.

10. The method according to claim 1, characterized in that the reference position is a position for which information has been given beforehand.

11. The method according to claim 1, characterized in that it also comprises a step in which the user indicates the reference position by selecting said reference position among a plurality of geographical positions for which information has been given beforehand, or by input of said reference position.

12. The method according to claim 12, characterized in that the reference position is selected from a list displayed on a screen showing the display window.

13. The method according to claim 1, characterized in that it also comprises, for at least one identified available site, a step of:
determining a distance separating said identified available site from the reference position, and
displaying said distance in association with said identified available site.

14. A use of the method according to claim 1 for identifying an available site for the automated rental of vehicles comprising:
a vehicle available for rental, with respect to a reference position, called departure position; or
a parking space available for returning a rented vehicle, with respect to a reference position, called arrival position;
within an installation for the automated rental of vehicles comprising a plurality of rental sites for the rental of a vehicle and/or for the return of a rented vehicle.

15. A method for reserving a vehicle within an installation for the automated rental of vehicles comprising a plurality of stations for the automated rental of vehicles distributed over an area, comprising:
locating at least one available station comprising at least one vehicle available for rental, with the method according to claim 1;
selecting an available station; and
reserving at least one vehicle for rental, in said selected station.

16. A method for reserving a parking space within an installation for the automated rental of vehicles comprising a plurality of rental stations distributed over an area, each station comprising at least one parking space, comprising:
locating at least one available station comprising at least one available parking space, with the method according to claim 1;
selecting an available station; and
reserving at least one parking space in said selected station.

17. A method for reserving a journey, within an installation for the automated rental of vehicles comprising a plurality of stations for the automated rental of vehicles distributed over an area, comprising:
reserving a vehicle in an available station, with respect to a reference position, called departure position, with the method for reserving a vehicle according to claim 15; and
reserving a parking space in an available station, with respect to a reference position, called arrival position, with the method for reserving a parking space according to claim 16.

18. A computer application for
a portable device, in particular of the smartphone, tablet or phablet type; or
a fixed device, of the desktop computer or terminal type;
private or public, comprising the instructions that can be executed by said device for implementing all the steps of the method according to claim 1, or for a use of the method according to claim 14.
